(19) United States
(12) Patent Application Publication
(10) Pub. No.: US 2004/0108709 A1
(43) Pub. Date: Jun. 10, 2004

(54) Construction for a book cover

(76) Inventor: Jeffrey L. Hengsbach, Mukwonago, WI (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/315,422

(22) Filed: Dec. 10, 2002

(51) Int. Cl. B42D 3/00

(52) U.S. Cl. 281/29

(57) ABSTRACT

An improved book cover which may be used in the manufacture of durable, high quality bound books is disclosed which is constructed of a transparent or semi-transparent cover sheet having opposed first and second surfaces. The cover sheet is printed on its second surface in a wrong-reading orientation, and the second surface of the cover sheet is then adhered to a frontpiece, a spine piece, and a backpiece. The improved book cover of the present invention eliminates the need for paper book coverings requiring expensive laminates or protective coatings, and provides increased durability and strength over such conventional book covers while also having a superior glossy appearance over conventional book cover constructions.

### BACKGROUND OF THE INVENTION

Field of the Invention

The present invention relates generally to the field of hard bound book cover manufacture, and more particularly to an improved construction for a hard bound book cover and a method of making an improved hard bound book cover.

Hard bound books require book covers having strength and durability to withstand many years of use. Educational textbooks, in particular, must meet federal, state, and industry imposed quality standards, attempting to maximize the useful life of the textbook in the most inexpensive way possible. Further, hard bound book covers must be attractive and must maintain their appearance throughout the life of the book. While both quality and durability are significant, cost effective production of hard bound books is also important.

Traditionally, hard bound books were covered using expensive materials such as cloth or leather. More recently, plastic-impregnated paper or other similar printable paper materials have been used to more economically manufacture book covers.

Paper-covered hard bound books are produced starting first with a sheet of opaque plastic-impregnated paper, or a similar printable paper product. The paper cover sheet has two surfaces, namely, a top or first surface which is the surface of the paper that is printed, and a bottom or second surface which is the nonprinted, underside of the paper. In the assembled book cover, the first surface of the cover sheet will become the exterior or outer surface of the book cover that will be viewed by the user, and the second surface of the cover sheet will become the surface that is glued or otherwise adhered directly to a sheet of bookbinders board to produce the book cover.

In the first step in the manufacturing process, the cover picture, design, and/or title of the textbook is printed on the first surface of the paper in a right-reading fashion. That is, the title words and/or images are printed on the first surface of the paper in the normal reading position and not laterally reversed. Since the paper is opaque, it will be appreciated that the printed words are readable from only the first surface of the sheet.

Next, because the printed, first surface ultimately becomes the exterior surface of the book cover and is exposed to damaging elements and abrasion, a protective top coat must be applied. Accordingly, after printing, a protective top coat is applied to the first surface of the printed cover sheet to protect the ink and the paper from damage. Commonly applied protective top coats include ultraviolet-cured coatings, water-based acrylics, varnish, or laminated materials. Laminate materials can include polypropylene, polyester, polyvinyl, nylon, or similar material of gauges generally ranging from 0.005 inch to 0.030 inch.

After lamination, animal glue or a similar adhesive is applied to the entire second surface of the cover sheet. The nonprinted, second surface is then mated and adhered to the outside surface of a frontpiece, a spine piece, and a backpiece, each of which is made of bookboard. The edges of the printed cover sheet are folded over and glued to the inside surfaces of the frontpiece, the spine, and the backpiece, thereby forming the corners and edges of the book cover.

When the book block (the pages of the book) are bound to the book cover, endsheets are then adhered to the book block and the inside surface of both the front and back cover pieces, covering the folded-over edges of the cover sheet and any exposed book board on the insides of the frontpiece and the backpiece.

It should be noted that applying a laminate or a protective coating to the printed cover sheet in the currently used process requires the use of expensive laminate or coating material. Further, application of a protective coating represents an additional step and therefore requires additional processing time and equipment. In addition, the laminated or coated first surface of the printed paper cover, while shiny in appearance at first, quickly looses its shine and durability with continued wear of the book. Exposure to heat, oil, or moisture can cause the laminate to separate or curl away from the printed sheet, or can cause any protective coating to be worn off, potentially destroying not only the ink and paper but the overall look and construction of the book cover.

In addition, the conventional paper book cover has only a very thin laminate or UV coating which provides little structural reinforcement to highly stressed portions of the book cover such as the hinges or the spine. In order to maximize the useful life of a hard bound book, it would be desirable to improve the strength of these high stress areas in the manufacture of book covers.

It is accordingly the primary objective of the present invention to provide both an improved book cover, and a method for the manufacture of such an improved book cover, constructed from a transparent or substantially transparent plastic or cellophane material which is printed in a wrong-reading (laterally reversed or mirror-image) fashion directly onto its second surface and adhered on that second surface to book board pieces, such that once the cover is adhered to the book board on this second side, the printed material appears in a readable orientation. It is a closely related objective of the present invention that the improved book cover construction have increased durability over conventional book cover constructions, and that it maximize protection of the printed ink and improve the durability and strength of the highly stressed portions of the book cover such as the hinge and the spine.

It is another objective of the present invention to provide an improved book cover construction in which the second/bottom surface is the printed surface while the first/top surface provides a high gloss appearance and protection for the printed ink, eliminating the need for subsequent lamination or UV coating of the printed side. It is a closely related objective that the improved book cover construction of the present invention minimize manufacturing costs and be more efficient to produce than conventional book cover constructions. It is yet another objective of the present invention that the improved book cover construction can be manufactured and subsequently bound to book blocks without requiring substantial revision to an existing manufacturing process or investment in new equipment.

It is a further object of the invention to provide an improved book cover with a high gloss, impressive appearance. It is a related object of the present invention to provide an improved book cover construction that can additionally be foil stamped, embossed, spot varnished, or have various other special effects added such as holograms before it is bound to the book board.

The improved book cover of the present invention must also be of construction which is both durable and long lasting, and it should also require little or no repair to be provided by the user throughout its operating lifetime. In order to enhance the market appeal of the improved book cover of the present invention, it should also be of inexpensive construction to thereby afford it the broadest possible market. Finally, it is also an objective that all of the aforesaid advantages and objectives of the improved book cover of the present invention be achieved without incurring any substantial relative disadvantage.

### SUMMARY OF THE INVENTION

The disadvantages and limitations of the background art discussed above are overcome by the present invention. With this invention, an improved book cover is provided constructed of a transparent or substantially transparent plastic or cellophane cover sheet which is printed on the second surface of the cover sheet in wrong-reading (laterally reversed or mirror-image) orientation, and subsequently adhered on the printed, second side to a frontpiece, a spine, and a backpiece, all of which are made of bookboard.

Typically, the cover sheet material of the present invention is provided on core rolls and, will first be “sheeted” or cut to a size predetermined by the final book requirements and the processing equipment. However, pre-sheeted material could also be used. The material used for the cover sheet includes such materials as cellophane, thermal laminating films such as materials sold under the registered trademark COVERLAM by Bryce Corporation or its licensees, nylon, vinyl, high density polyethylene films such as those sold under the registered trademark VALERON by Illinois Tools Works, Inc. or its licensees, polystyrene, polypropylene, polyethylene, polyester (PET) or any similar thin, transparent or substantially transparent material.

Once sheeted to the required size, the cover sheet is printed such that the cover design, title and other images are printed in a wrong-read (laterally reversed or mirror-image) orientation on the second (back) side of the cover sheet. After the ink is cured and/or dried, the cover sheet may subsequently be foil stamped, embossed, spot varnished, or have any number number of effects such as holograms added before being mated with bookboard pieces.

The bookbinders board pieces provide structure to the printed cover sheet in the construction of the hard book cover. The bookboard material is cut into pieces corresponding to the front (the frontpiece), spine (the spine piece) and back (the backpiece) of the book. Each piece is sized according to the required dimensions of the pages to be bound. The bookboard material can be cardboard, paperboard material such as the type sold under the registered trademark MAXITE by Book Covers, Inc. or its licensees, heavy gauge plastic, or any other similar material.

After printing, adhesive is applied to the second, printed surface of the cover sheet. The frontpiece, the spine piece, and the backpiece are mated with the adhesive-coated second surface of the cover sheet and are positioned so that each is properly aligned with the front, spine, and back portions of the book cover. One entire side of each of the bookboard pieces is adhered to the second surface of the cover sheet. Excess cover sheet material is folded over and adhered to the interior surface of the frontpiece, the spine piece, and the backpiece, thereby forming the edges and the corners of the book cover.

The adhesive used in the present invention to adhere the printed plastic or cellophane cover sheet directly to the bookboard segments is preferably a liquid animal glue, a pressure sensitive, hot melt adhesive such as the type sold under the registered trademark ULTRACASE by National Starch and Chemical Co. or its licensees, or a radiation-cured adhesive such as the type sold under the registered trademark CONTOUR by National Starch and Chemical Co. or its licensees, including ultraviolet curable adhesives. The adhesive is applied to the second surface of the cover sheet using conventional equipment or slightly modified conventional equipment. In the case of a radiation-cured adhesive, the cover sheet is subsequently irradiated to activate the adhesive to adhere the book cover to the bookboard pieces.

Endsheets are bound to the book block (the pages of the book) and their free ends are equal in size or slightly smaller than the frontpiece and the backpiece. The endsheets are adhered to the interior surfaces of the frontpiece and the backpiece so that both the folded-over cover sheet edges and the remaining visible bookboard are covered by the endsheets. The endsheets will typically be constructed of heavy paper or similar material and adhered both to the front cover and the back cover and the end pages of the bound book block.

It may therefore be seen that the present invention teaches both an improved book cover, and a method of making such an improved book cover, which is constructed of a substantially transparent material such as plastic or cellophane that is printed in wrong-reading (laterally reversed or mirror-image) orientation on its second surface and adhered on that second surface directly to a frontpiece, a spine piece, and a backpiece made of bookboard. The improved book cover of the present invention has a glossy first surface that is attractive in appearance and highly durable, without the use of either lamination or UV coating. By eliminating the need for laminating or UV coating the book cover, the improved book cover of the present invention may be less expensive and/or more efficient to produce than are the conventional paper book covers.

The improved book cover of the present invention is of a construction which is both durable and long lasting, and which will require little or no repair to be provided by the user throughout its useful lifetime. The book cover of the present invention is also of relatively inexpensive construction to enhance its market appeal and to thereby afford it the broadest possible market. Finally, all of the aforesaid advantages and objectives of the improved book cover of the present invention are achieved without incurring any substantial relative disadvantage.

### DESCRIPTION OF THE DRAWINGS

These and other advantages of the present invention are best understood with reference to the drawings, in which:

FIG. 1 is a plan view of the nonprinted first or front surface of the cover sheet used to construct the improved book cover of the present invention, with a corner turned up to show a second surface thereof;

FIG. 2 is a plan view of the second surface of the cover sheet illustrated in FIG. 1, showing wrong-reading (laterally reversed or mirror-image) indicia printed upon the second surface thereof;

FIG. 3 is a plan view of the first surface of the cover sheet illustrated in FIGS. 1 and 2, with the indicia printed on the second surface being clearly visible in readable orientation through the cover sheet;

FIG. 4 is a plan view of the second surface of the cover sheet used to construct the improved book cover illustrated in FIGS. 1-3, showing the frontpiece, the spine piece and the backpiece positioned on the cover sheet and aligned with the image area;

FIG. 5 is a plan view of the back side of an improved book cover constructed according to the teachings of the present invention, showing the interior surface thereof with edges folded over onto the second surface;

FIG. 6 is a plan view of the front side of an improved book cover illustrated in FIG. 5, showing the exterior surface thereof;

FIG. 7 is a cross-sectional view of the improved book cover illustrated in FIGS. 5 and 6 along the line 7-7 shown in FIG. 5, showing the cover sheet, printed indicia and adhesive layers, and the frontpiece, the spine piece and backpiece;

FIG. 8 is a perspective view of the improved book cover illustrated in FIGS. 1-8 bound to a book block and showing the attachment of the end sheets; and

FIG. 9 is a perspective view of the improved book cover illustrated in FIGS. 1-9 bound to a book block.

### DETAILED DESCRIPTION OF THE PREFERRED EMBODIMENT

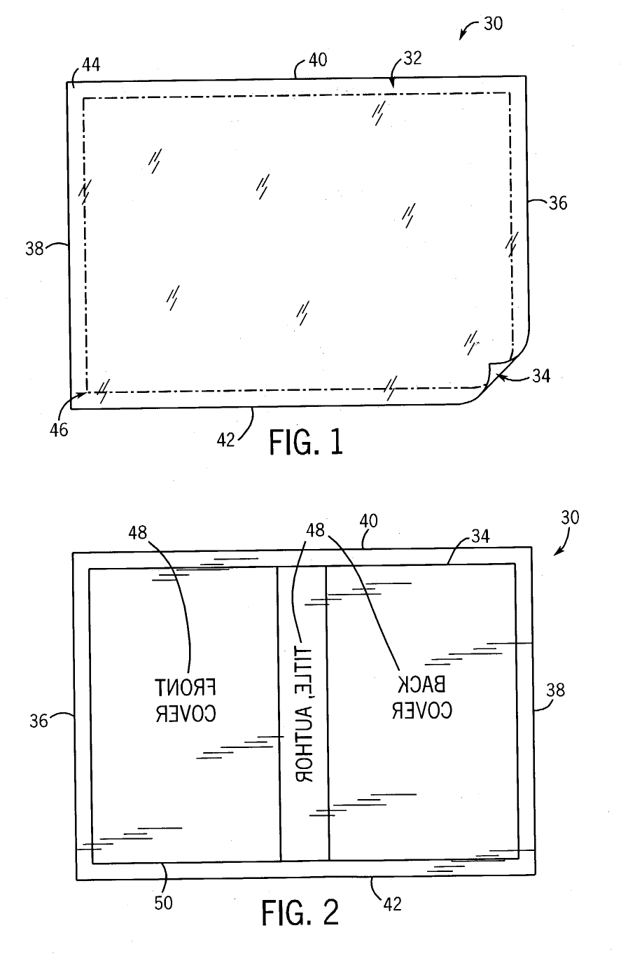

Consistent with the teachings of the present invention, the heart of an improved book cover is a transparent or semi-transparent cover sheet 30 of novel construction, illustrated in FIG. 1. The improved book cover in its simplest form will consist of the cover sheet 30, having a front or first surface 32 and a back or second surface 34. The cover sheet 30 will have indicia (not shown in FIG. 1) printed in a wrong-reading (laterally reversed or mirror-image) orientation on the second surface 34 thereof. The improved cover sheet 30 of the present invention will have its second surface 34 adhesively secured to a frontpiece, a spine piece, and a backpiece of bookbinders board to manufacture a book cover as discussed below in conjunction with FIGS. 4 through 7, and will then have the pages of a book bound to the book cover as discussed below in conjunction with FIGS. 8 and 9.

Referring then to FIG. 1, the construction of the cover sheet 30 used in the manufacture of an improved book cover is described. In addition to the first surface 32 and the second surface 34, the cover sheet 30 has a right edge 36, a left edge 38, a top edge 40, and a bottom edge 42.

The cover sheet 30 is constructed of a thin, flexible transparent or semi-transparent material. The transparent or semi-transparent material may be cellophane, a thermal laminating film like materials sold under the registered trademark COVERLAM by Bryce Corporation or its licensees, nylon, vinyl, a high density polyethylene film such as those sold under the registered trademark VALERON by Illinois Tools Works, Inc. or its licensees, polystyrene, polypropylene, polyethylene, polyester (PET) or any combination thereof. In addition, the cover sheet material may be tinted a visible color, provided that the cover sheet 30 remains substantially transparent.

The transparent or semi-transparent material is typically supplied as a roll wound on a core, and is cut into sheets, thereby forming the cover sheet 30. Alternatively, the transparent or semi-transparent material may be supplied from the manufacturer in pre-sheeted form and subsequently trimmed, if needed, to a specific size. The cover sheet 30 will be generally rectangular in shape, and is sized corresponding to the requirements of the final book product, page size, and processing equipment requirements.

As illustrated in FIG. 1, the cover sheet 30 has an overall surface area, indicated generally at 44, that is larger than the profile of the completed front cover, spine, and back cover, which is indicated generally at 46 (shown in broken lines for illustrative purposes in FIG. 1). Thus, the size of the overall surface area 44 of the cover sheet 30 is such that the edges 36, 38, 40, and 42 of the cover sheet 30 will extend beyond the profile 46 as the improved book cover is assembled. While the cover sheet 30 is shown as being rectangular in shape, it will at once be appreciated by those skilled in the art that the cover sheet 30 can be of any shape or size required by the final book product to be bound.

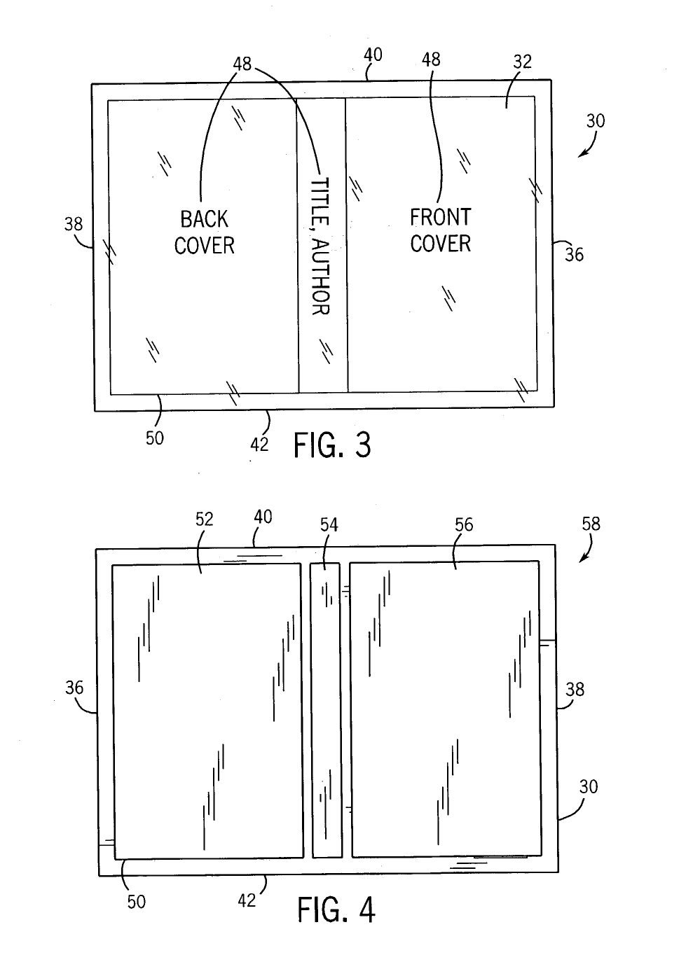

Referring next to FIGS. 2 and 3, a printed indicia 48 such as the book's title, cover image, and/or cover artwork is printed in a wrong-reading (laterally reversed or mirror image) orientation directly on the second surface 34 of the cover sheet 30. Accordingly, the printed indicia 48 appears in a mirror-image or backwards direction when viewed from the second surface 34 (as shown in FIG. 2). Because the cover sheet 30 is transparent or semi-transparent, the printed indicia 48 appears in a right-reading (readable) orientation when viewed from the first surface 32 of the cover sheet 30 (as shown in FIG. 3).

As illustrated in FIGS. 2 and 3, any printed indicia 48 intended to appear on the exterior surface of the finished book's front cover, spine, and back cover will be printed within an image area 50 on the second surface 34 of the cover sheet 30. The image area 50 will substantially correspond to the profile 46 of the front cover 42, spine, and back cover, but it will typically be slightly larger than the profile 46 so as to cover the edges of the book cover as well as the front, spine, and back of the book cover.

The printed indicia 48 is printed on the second surface 34 of the cover sheet 30 using any one-color or multi-color sheetfed press known to those skilled in the art. Preferably, an ultraviolet (UV) cured ink will be used to print the printed indicia 48. However, a heatset, coldset, or any other conventional ink known to those skilled in the art may also be used to print the printed indicia 48 on the second side 34 of the cover sheet 30. In addition, web offset printing may be used to print the cover sheet 30 of the improved book cover of the present invention. In the web offset application, the transparent or semi-transparent material would be provided on rolls, and the material would be web-printed and subsequently cut into cover sheets 30 of the required size.

In addition to the indicia 48 printed on the second surface 34, the cover sheet 30 may be foil stamped, embossed, spot varnished, or have various other special effects, such as holograms, added to the second surface 34 of the cover sheet 30. Other embodiments of the improved book cover of the present invention can additionally include printed indicia, foil stamping, varnish, or other various effects, such as holograms, applied to the first surface 32 of the cover sheet 30 either in addition to or instead of the printed indicia 48 applied to the second surface 34 of the cover sheet 30.

Referring now to FIG. 4, a frontpiece 52, a spine piece 54, and a backpiece 56 made of bookbinders board or a similar material are used to provide structure to the improved book cover by imparting stiffness and rigidity to the cover sheet 30. The frontpiece 52, the spine piece 54, and the backpiece 56 are sized according to the size of the particular pages to be bound and the particular book cover application. As noted above, the profile 46 of the completed front cover, spine, and back cover will be generally smaller than the overall surface area 44 of the cover sheet 30.

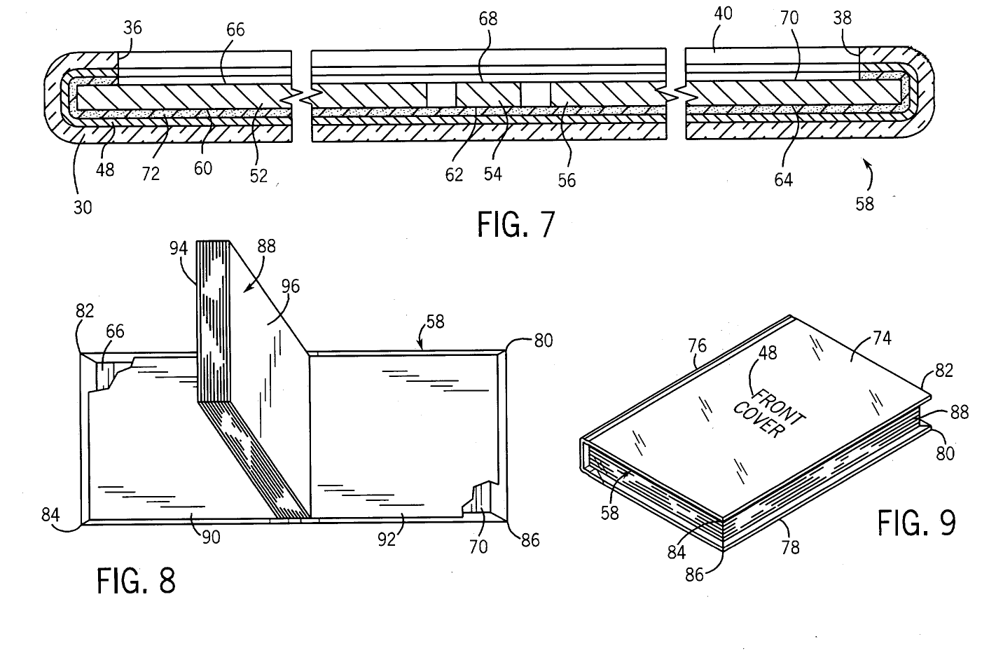

Referring now to FIGS. 5 through 7 in addition to FIG. 4, a book cover 58 made of the cover sheet 30 and the frontpiece 52, the spine piece 54, and the backpiece 56 is illustrated. As best shown in FIG. 7, the frontpiece 52, the spine piece 54, and the backpiece 56 have first, exterior surfaces indicated generally at 60, 62, and 64, respectively, and second, interior surfaces indicated generally at 66, 68, and 70, respectively. When the improved book cover 58 is assembled, the first surfaces 60, 62, and 64 of the frontpiece 52, the spine piece 54, and the backpiece 56, respectively, will become the exterior or outside faces of the improved book cover 58. Likewise, the second surfaces 66, 68, and 70 of the frontpiece 52, the spine piece 54, and the backpiece 56, respectively, will become the interior or inside faces of the improved book cover 58.

The frontpiece 52, the spine piece 54, and the backpiece 56 can be constructed of unbleached kraft paper, e-flute corrugated board, cardboard, paperboard material such as that sold under the registered trademark MAXITE by Book Covers, Inc. or its licensees, heavy gauge plastic or any other material known in the art that imparts the stiffness to the cover sheet 30 which is required by the specific book cover application.

It will thus be apparent to those skilled in the art that the improved book cover 58 and the method of manufacture of the improved book cover 58 of the present invention can be used to construct a soft or flexible book cover. In this application, the printed cover sheet 30 will be mated with a heavy gauge paper, a flexible plastic, or another flexible material to create a soft book cover, rather than using the rigid or stiff bindersboard pieces used in the preferred hard bound application. Further, a soft cover application of the present invention can include using a printed cover sheet 30 of a thicker transparent or semi-transparent material for the book cover construction.

As best shown in FIG. 7, an adhesive 72 is applied to the second surface 34 of the cover sheet 30 over the printed indicia 48 on the second surface 34, covering the entire overall surface area 44 (shown in FIG. 4) of the second surface 34 of the cover sheet 30. The adhesive 72 may be a liquid animal glue, a pressure sensitive hot melt adhesive, a radiation-cured adhesive including ultraviolet curable adhesives or a hybrid thereof. The adhesive 72 is applied using conventional or slightly modified adhesive application systems known in the art. Subsequently, the cover sheet 30 will be placed into position with respect to the frontpiece 52, the spine piece 54, and the backpiece 56 (as shown in FIG. 4), and will then be wrapped around the edges of these components (as shown in FIGS. 5 through 7). If a radiation-cured adhesive is used, the adhesive 70 is then be activated or irradiated with the required light source. It will be readily apparent that any UV adhesive or other adhesive including animal glue or hybrids thereof known to those skilled in the art may be used provided that it adequately adheres the plastic or cellophane cover sheet 30 to the frontpiece 52, the spine piece 54, and the backpiece 56 without destroying the printed indicia 48 on the second surface 34 of the cover sheet 30.

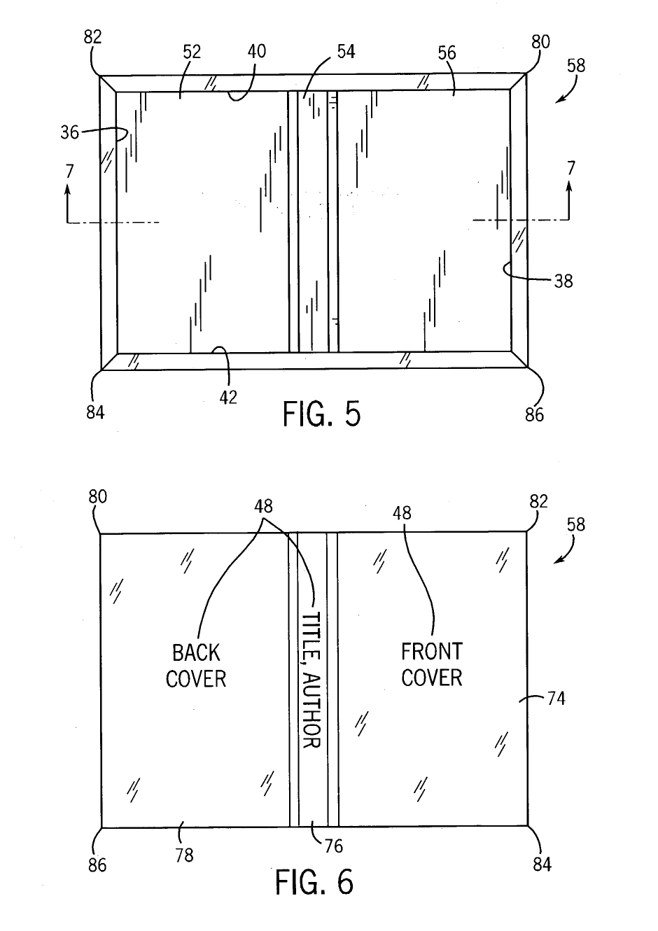

After the adhesive 72 is applied to the second surface 34 of the cover sheet 30, the frontpiece 52, the spine piece 54, and the backpiece 56 (which are best illustrated in FIGS. 5 and 6) are mated with the adhesive-coated second surface 34 of the cover sheet 30, thereby forming a front cover 74, a spine 76, and a rear cover 78, respectively. The frontpiece 52, the spine piece 54, and the backpiece 56 are aligned with the image area 50, corresponding to the printed indicia 48 that will appear on the front cover 74, the spine 76, and the back cover 78 of the book cover 58 (as best shown in FIG. 6).

After the first surfaces 60, 62, and 64 of the frontpiece 52, the spine piece 54, and the backpiece 56 (which may all be constructed of bookboard), respectively, are mated with the cover sheet 30, the adhesive-coated second surface 34 of the cover sheet 30 will extend beyond the frontpiece 52, the spine piece 54, and the backpiece 56. The edges 36, 38, 40, and 42 of the cover sheet 30 are then folded over onto the second surfaces 66, 68, and 70 of the frontpiece 52, the spine piece 54, and the backpiece 56, respectively, and adhered thereto (as best shown in FIGS. 5 and 7).

As best shown in FIGS. 5 and 8, four corners 80, 82, 84, and 86 of the book cover 58 are formed when the edges 36, 38, 40, and 42 of the cover sheet 30 are folded over and adhered to the second surfaces 66, 68, and 70 of the frontpiece 52, the spine piece 54, and the backpiece 56, respectively. The corners 80, 82, 84, and 86 may be of the type traditionally folded on conventional case making machines, and can be rounded, square, library, or any other corner type known to those skilled in the art. The corners 80, 82, 84, and 86 may be trimmed prior to being fed to a conventional case making machine, or may be formed as part of the case making operation.

Referring next to FIGS. 8 and 9, when a book block 88 is bound to the improved book cover 58, a pair of endsheets 90 and 92 are provided. The first endsheet 90 is adhered to both the frontpiece 52 and to an end page 94 at the beginning of the book block 88, covering the exposed second surface 66 of the frontpiece 52 and the folded-over edges-36, 40 and 42 of the cover sheet 30. Likewise, the second endsheet 92 is adhered to both the backpiece 56 and to an end page 96 at the end of the book block 88, covering the exposed second surface 70 of the backpiece 56 and the folded-over edges 38, 40, and 42 of the cover sheet 30.

It may therefore be that the present invention teaches both an improved book cover construction and a method of making such an improved book cover. The improved book cover of the present invention is constructed of a novel transparent or semi-transparent plastic or cellophane cover sheet which is printed in a wrong-reading or laterally reversed orientation on its second surface and front, spine and back pieces of binders board that are adhered directly the printed, second surface of the cover sheet. Accordingly, the improved book cover construction of the present invention protects the printed indicia and the bindersboard material without the need for application of a laminate or protective coating that may separate from or be worn off of the cover sheet.

Further, it may been that the present invention provides an improved book cover that is constructed of a plastic or cellophane-type material which provides the book cover with increased strength and durability, especially in highly stressed areas of the book cover like the hinges or spine. The improved book cover of the present invention additionally provides a book cover having a superior gloss over conventional book covers.

The improved book cover construction of the present invention provides a book cover which can reduce costs and/or increase efficiency of the manufacturing process by eliminating both the use of paper for the cover sheet and the use of laminate or protective coatings in the book cover manufacturing process. Accordingly, the improved book cover of the present invention may also weigh less than conventional book covers and are therefore less expensive to ship than the conventional book covers.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. A book cover comprising:
a substantially transparent sheet, said substantially transparent sheet having opposite first and second surfaces and edges;
cover indicia applied to said second surface of said substantially transparent sheet in a wrong-reading orientation;
an adhesive layer applied to said second surface of said substantially transparent sheet; and
a frontpiece, a backpiece, and a spine piece positioned between said frontpiece and backpiece, said pieces together defining a profile, each of said frontpiece, said backpiece, and said spine piece having a first surface and a second surface;
wherein said first surfaces of said frontpiece, said backpiece, and said spine piece are adhered to said second surfaces of said substantially transparent sheet such that said edges of said substantially transparent sheet project beyond said profile of said frontpiece, said spine piece, and said backpiece are folded over onto said second surfaces of said frontpiece, said backpiece, and said spine piece and adhered thereto.

2. A book cover as defined in claim 1, wherein said substantially transparent sheet is made from a material selected from the group consisting of cellophane, thermal laminating film, nylon, vinyl, high density polyethylene film, polystyrene, polypropylene, polyester (PET) and any combination thereof.

3. A book cover as defined in claim 1, wherein said substantially transparent sheet is tinted to a visible color.

4. A book cover as defined in claim 1, wherein said substantially transparent sheet is foil stamped, embossed, hologrammed or spot varnished on at least one of said first surface and said second surface.

5. A book cover as defined in claim 1, wherein said substantially transparent sheet has indicia printed on said first surface.

6. A book cover as defined in claim 1, wherein said cover indicia is printed on said second surface of said substantially transparent sheet using a sheetfed press.

7. A book cover as defined in claim 6, wherein said sheetfed press is selected from the group consisting of a one-color sheetfed press, a two-color sheetfed press, and a multi-color sheetfed press.

8. A book cover as defined in claim 1, wherein said cover indicia is printed using ultraviolet-cured ink.

9. A book cover as defined in claim 1, wherein said adhesive is a liquid animal glue, a pressure sensitive hot melt adhesive, a radiation-cured adhesive or a hybrid thereof.

10. A book cover as defined in claim 1, wherein said frontpiece, said spine piece, and said backpiece are constructed from unbleached kraft paper, e-flute corrugated board, cardboard, paperboard material sold under the registered trademark MAXITE by Book Covers, Inc. or its licensees, or heavy gauge plastic.

11. A book cover as defined in claim 1, further comprising first and second endsheets, wherein said first endsheet is adhered to said frontpiece on said second surface thereof and said second endsheet is adhered to said backpiece on said second surface thereof, wherein said endsheets cover said folded-over edges of said substantially transparent sheet.

12. A book cover comprising:
a substantially transparent sheet, said substantially transparent sheet having first and second surfaces;
indicia applied to said second surface of said substantially transparent sheet in a wrong-reading orientation;
an adhesive applied to said second surface of said substantially transparent sheet; and
front and back cover boards and a spine board positioned between said front and back cover boards, each of said front cover board, said back cover board, and said spine board being adhered to said second surface of said substantially transparent sheet by said adhesive.

13. A book cover as defined in claim 12, wherein said substantially transparent sheet is made from a material selected from the group consisting of cellophane, thermal laminating film, nylon, vinyl, high density polyethylene film, polystyrene, polypropylene, polyester (PET) and any combination thereof.

14. A book cover as defined in claim 12, wherein said substantially transparent sheet is tinted to a visible color.

15. A book cover as defined in claim 12, wherein said substantially transparent sheet is foil stamped, embossed, hologrammed or spot varnished on at least one of said first surface and said second surface.

16. A book cover as defined in claim 12, wherein said substantially transparent sheet has indicia printed on said first surface.

17. A book cover as defined in claim 12, wherein said indicia is printed on said second surface of said substantially transparent sheet using a sheetfed press.

18. The book cover as defined in claim 17, wherein said sheetfed press is a one-color sheetfed press, a two-color sheetfed press, or a multi-color sheetfed press.

19. A book cover as defined in claim 17, wherein said indicia is printed using ultraviolet-cured ink.

20. A book cover as defined in claim 12, wherein said adhesive is a liquid animal glue, a pressure sensitive hot melt adhesive, a radiation-cured adhesive or a hybrid thereof.

21. A book cover as defined in claim 12, wherein said front and back cover boards and said spine board are constructed from a material selected from the group consisting of kraft paper, cardboard, paperboard material sold under the registered trademark MAXITE by Book Covers, Inc. or its licensees, and heavy gauge plastic.

22. A book cover comprising:
a substantially transparent sheet, said substantially transparent sheet having first and second surfaces;
printed indicia applied to said second surface of said substantially transparent sheet; and
a frontpiece, a spine piece and a backpiece adhered to said second surface of said substantially transparent sheet.

23. A book cover as defined in claim 22, wherein said printed indicia is applied to said second surface of said substantially transparent sheet in a wrong-reading orientation.

24. A book cover as defined in claim 22, wherein said substantially transparent sheet is made from cellophane, thermal laminating film, nylon, vinyl, high density polyethylene film, polystyrene, polypropylene, polyester (PET) or any combination thereof.

25. The book cover as defined in claim 22, wherein said substantially transparent sheet is tinted to a visible color.

26. The book cover as defined in claim 22, wherein said substantially transparent sheet is foil stamped, embossed, hologrammed or spot varnished on at least one of said first surface and said second surface.

27. A book cover as defined in claim 22, wherein said substantially transparent sheet has indicia printed on said first surface.

28. A book cover as defined in claim 22, wherein said printed indicia is applied using ultraviolet-cured ink.

29. The book cover as defined in claim 22, wherein said frontpiece, said spine piece, and said backpiece are adhered to said second surface of said substantially transparent sheet using a liquid animal glue, a pressure sensitive hot melt adhesive, a radiation-cured adhesive or a hybrid thereof.

30. The book cover as defined in claim 22, wherein said frontpiece, said spine piece and said backpiece are constructed of kraft paper, cardboard, paperboard material sold under the registered trademark MAXITE by Book Covers, Inc. or its licensees, or heavy gauge plastic.

31. A method for making an improved book cover comprising:
providing a substantially transparent sheet, said substantially transparent sheet having first and second surfaces and four edges;
applying cover indicia to said second surface of said substantially transparent sheet in a wrong-reading orientation;
applying an adhesive to said second surface of said substantially transparent sheet;
providing a frontpiece, a backpiece, and a spine piece positioned between said frontpiece and backpiece, each of said frontpiece, said backpiece, and said spine piece having a first surface and a second surface respectively;
adhering said first surfaces of said frontpiece, said backpiece, and said spine piece to said second surfaces of said substantially transparent sheet; and
folding over and adhering said edges of said substantially transparent sheet onto said second surfaces of said frontpiece, said backpiece, and said spine piece.

32. A method for making an improved book cover as defined in claim 31, wherein said substantially transparent sheet is made from cellophane, thermal laminating film, nylon, vinyl, high density polyethylene film, polystyrene, polypropylene, polyester (PET) or any combination thereof.

33. A method for making an improved book cover as defined in claim 21, wherein said substantially transparent material is tinted to a visible color.

34. A method for making an improved book cover as defined in claim 31, further comprising:
applying a further finishing effect to at least one of said first surface and said second surface.

35. A method for making an improved book cover as defined in claim 34, wherein said further effect comprises foil stamping, embossing, hologramming or spot varnishing.

36. A method for making an improved book cover as defined in claim 31, further comprising:
applying printed indicia to said first surface of said substantially transparent sheet and further applying a protective coating to said printed indicia applied to said first surface of said sheet.

37. A method for making an improved book cover as defined in claim 31, wherein cover indicia is applied to said second surface of said sheet using a sheetfed press.

38. A method for making an improved book cover as defined in claim 37, wherein said sheetfed press is one of a one-color sheetfed press, a two-color sheetfed press, and a multi-color sheetfed press.

39. A method for making an improved book cover as defined in claim 31, wherein said cover indicia is printed using ultraviolet-cured ink.

40. A method for making an improved book cover as defined in claim 31, wherein said adhesive is a liquid animal glue, a pressure sensitive hot melt adhesive, a radiation-cured adhesive or a hybrid thereof.

41. A method for making an improved book cover as defined in claim 31, wherein said frontpiece, said spine piece, and said backpiece are constructed from kraft paper, cardboard, paperboard material sold under the registered trademark MAXITE by Book Covers, Inc. or its licensees, or heavy gauge plastic.

42. A method for making an improved book cover comprising:
providing a substantially transparent material;
cutting said substantially transparent material into a substantially rectangular sheet, said sheet having a first surface, a second surface, and four edges;
printing cover indicia on said second surface of said sheet in wrong-reading orientation;
applying an adhesive layer to said second surface of said sheet;
providing a front cover board, and a back cover board, and a spine board positioned between said front and back cover boards, each of said front cover board, said back cover board, and said spine board having a first surface and a second surface; and
adhering said first surfaces of said front cover board, said back cover board, and said spine board to said second surface of said sheet.

43. A method for making an improved book cover as defined in claim 42, further comprising:
folding over and adhering said four edges of said sheet onto said second surface of said front cover board, said back cover board, and said spine board.

44. A method for making an improved book cover as defined in claim 42, wherein said substantially transparent material is made from a material selected from the group consisting of cellophane, thermal laminating film, nylon, vinyl, high density polyethylene film, polystyrene, polypropylene, polyester (PET) and any combination thereof.

45. A method for making an improved book cover as defined in claim 42, wherein said substantially transparent material is tinted to a visible color.

46. A method for making an improved book cover as defined in claim 42, further comprising:
applying a further effect to said sheet, said further effect comprising foil stamping, embossing, hologramming or spot varnishing said sheet on at least one of said first surface and said second surface.
